(19) United States
(12) Patent Application Publication
(10) Pub. No.: US 2009/0235223 A1
(43) Pub. Date: Sep. 17, 2009

(54) PROGRAM GENERATION APPARATUS AND PROGRAM GENERATION METHOD

(76) Inventors: Shingo KAKUI, Inagi-shi (JP); Yutaka Ueno, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/350,597

(22) Filed: Jan. 8, 2009

(30) Foreign Application Priority Data
Mar. 12, 2008 (JP) 2008-062941

(51) Int. Cl. G06F 17/50

(52) U.S. Cl. 716/18

(57) ABSTRACT

According to one embodiment, a software generation apparatus generates software for verifying a RTL description obtained by high-level synthesis of an operation description describing an LSI operation. The apparatus comprises a judgment function generation module configured to generate a judgment function based on a test program for verifying the operation description and an execution cycle number, the judgment function starting a process of determining whether the relationship between the input value and the output value is an expected relation when the number of times of receiving a pair of an input value and an output value from the test program exceeds the execution cycle number.

### CROSS-REFERENCE TO RELATED APPLICATIONS

This application is based upon and claims the benefit of priority from Japanese Patent Application No. 2008-062941, filed Mar. 12, 2008, the entire contents of which are incorporated herein by reference.

### BACKGROUND

1. Field

One embodiment of the invention relates to program generation apparatus and method for generating software for verifying a register transfer level (RTL) description obtained by high-level synthesis.

2. Description of the Related Art

Recently, the semiconductor technology advances, and thereby, a high-function LSI or VLSI has come to wide use. Now, the development of the following LSI has been made. The LSI processes data stream such as moving image in real time.

High-level synthesis has been known as a tool for supporting a design of the foregoing LSI. According to the high-level synthesis, a resister transfer level (RTL) description is generated from an operation description describing the LSI operation using a high-level programming language such as C. The resister transfer level (RTL) description is a hardware-level description, which includes clock/cycle and a register. The high-level synthesis is used, and thereby, the time spent for designing the LSI is shortened.

In a design process of the LSI using the high-level synthesis, there is a need of testing the operation description by a test program (C test bench) to verify the content of the operation description in C.

The RTL description is generated by the high-level synthesis of the operation description. Thereafter, there is a need of verifying the content of the RTL description. In this case, a special test program for verifying the RTL description must be newly prepared. Conventionally, the special test program for verifying the RTL description is manually prepared. For this reason, much time is spent for the process of preparing the program.

Jpn. Pat. Appln. KOKAI Publication No. 2007-310449 discloses a system, which verifies a hardware model using an interface between a software model and a hardware model.

In the system, the hardware model is called via a driver when a test program for the software model is executed. The processing result executed on the hardware model is returned to the software model test program. The processing result of the hardware model is compared with the processing result executed in the software model. Based on the comparison result, the hardware model is verified.

If the foregoing system is realized, the software model test program is applicable to a test for the hardware model.

However, in the system disclosed in the foregoing Publication, no consideration is made with respect to verification of a hardware model designed so that each processing of input values is successively executed.

The LSI handling data stream in real time requires the following processing and operation. Namely, the LSI processes a series of inputs while successively inputs it every clock cycle. A predetermined clock cycle elapsed, and thereafter, the LSI successively outputs a series of outputs corresponding to the series of inputs every clock cycle.

The system disclosed in the foregoing Publication has the following configuration. According to the configuration, the system waits until an output corresponding to a certain input is returned from the hardware model, and thereafter, gives the next input to the hardware model. In other words, the system does not give the next input to the hardware model until an output corresponding to a certain input is returned from the hardware model. Therefore, it is difficult to make an operation test of the LSI designed so that each processing of input values is successively executed.

Thus, there is a need of realizing a new tool for easily generating software capable of correctly verifying the RTL description (e.g., hardware model including a pipeline circuit) of a LSI designed so that each processing of input values is successively executed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a system configuration of a software generation apparatus according to an embodiment of the invention;

FIG. 2 is an exemplary view to explain that the software generation apparatus of the embodiment functions as a test bench conversion system;

FIG. 3 is an exemplary view to explain each configuration of a program group generated by the software generation apparatus of the embodiment;

FIG. 4 is an exemplary flowchart to explain the procedure executed by a judgment function generated by the software generation apparatus of the embodiment; and

FIG. 5 is an exemplary flowchart to explain the procedure of a test bench conversion processing executed by the software generation apparatus of the embodiment.

### DETAILED DESCRIPTION

Various embodiments according to the invention will be described hereinafter with reference to the accompanying drawings. In general, according to one embodiment of the invention, there is provided a software generation apparatus for generating software for verifying a RTL description obtained by high-level synthesis of an operation description describing an LSI operation using a high-level programming language, comprising: a storage device configured to store a test program for verifying the operation description; and a judgment function generation module configured to generate a judgment function based on the test program and an execution cycle number indicating a cycle number spent until an output value corresponding to an input value is output after the RTL description inputs the input value, the judgment function starting a process of determining whether the relationship between the input value and the output value is an expected relation when the number of times of receiving a pair of an input value and an output value from the test program exceeds the execution cycle number, and the test program and the judgment function functioning as the software.

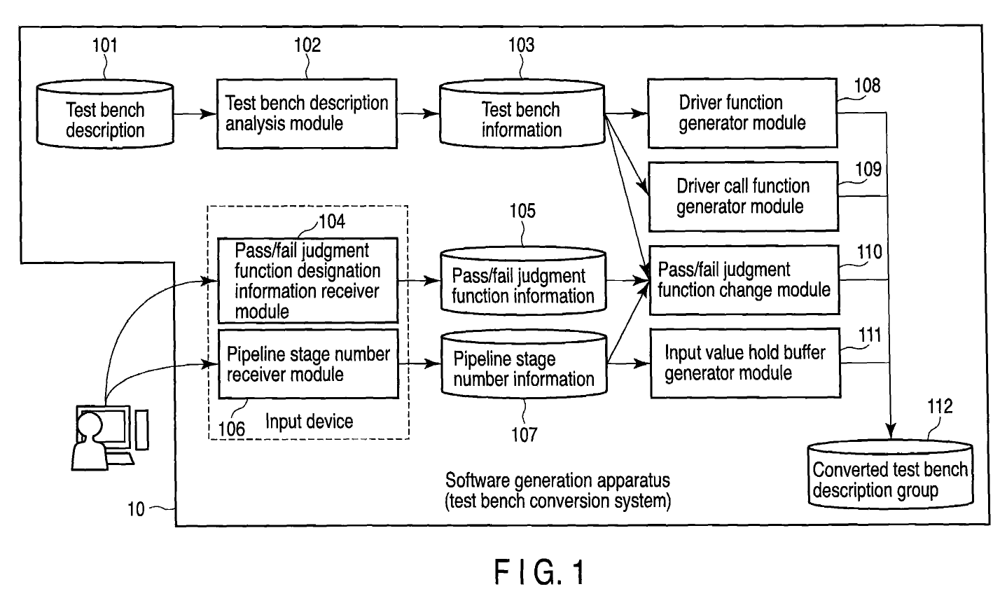

FIG. 1 is a block diagram showing the configuration of a software generation apparatus 10 according to one embodiment of the present invention. The software generation apparatus 10 is an apparatus for generating software for verifying a register transfer level (RTL) description obtained by high-level synthesis of an operation description describing an LSI operation using a high-level programming language. The software for verifying the RTL description is automatically generated using a test program prepared for verifying the operation description.

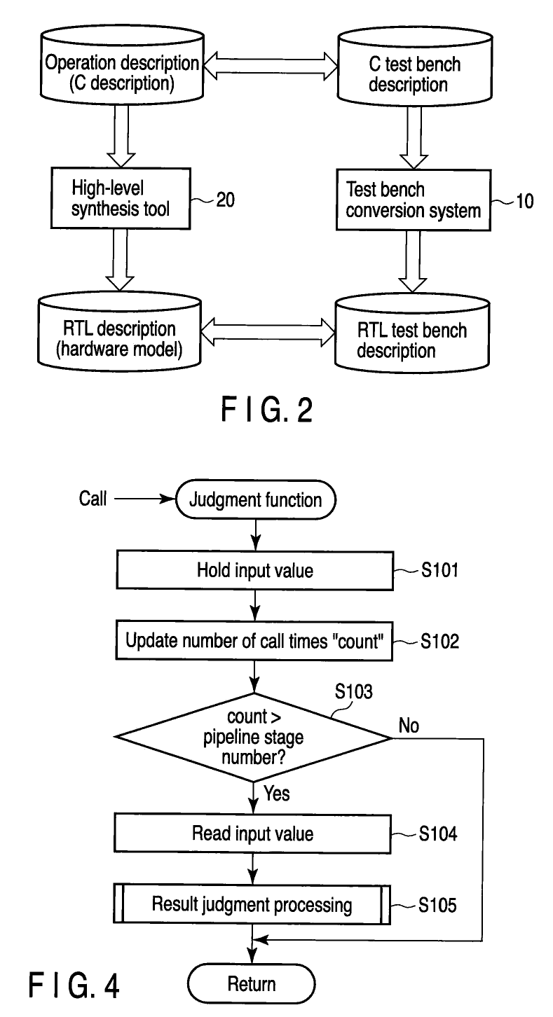

Specifically, the software generation apparatus 10 functions as a test bench conversion system as shown in FIG. 2. For example, the test bench conversion system automatically converts a test program (C test bench description) verifying an LSI operation description (C description) in C to software (RTL test bench description) for verifying an RTL description.

The operation description describes only an operation (function) of a design target LSI using a high-level programming language such as C. The RTL description describes the configuration of the LSI at a hardware level including clock cycle and a register. The RTL description is automatically generated according high-level synthesis of the operation description using a high-level synthesis tool 20. The high-level synthesis tool 20 is realized by software for executing high-level synthesis.

The software generation apparatus 10 is realized by a computer, which is installed with a test bench conversion program. The test bench conversion program is a program for converting a C test bench description for verifying an operation description to a RTL test bench description for verifying a RTL description.

As shown in FIG. 1, the software generation apparatus 10 includes a test bench description storage module 101, a test bench description analysis module 102, a test bench information storage module 103 and a pass/fail judgment function designation information receiver module 104. The apparatus 10 further includes a pass/fail judgment function information storage module 105, a pipeline stage number receiver module 106, a pipeline stage number information storage module 107. The apparatus 10 further includes a driver function generator module 108, a driver call function generator module 109, a pass/fail judgment function change module 110, an input value hold buffer generator module 111 and a conversion result storage module 112. The conversion result storage module 112 stores a converted test bench description group. The foregoing test bench description analysis module 102, pass/fail judgment function designation information receiver module 104, pipeline stage number receiver module 106, driver function generator module 108, driver call function generator module 109, pass/fail judgment function change module 110, and input value hold buffer generator module 111 are realized as a function module forming the test bench conversion program.

The test bench description storage module 101 stores a C test bench description for verifying an LSI operation description in C. The C test bench description is written in a language such as C. Thus, the C test bench description is called a test program. The C test bench description describes the following procedures. One is a procedure of giving an input to a test target function (describing an LSI operation) included in the operation description in C. Another is a procedure of obtaining an output (returned value) from the test target function. Another is a procedure of determining (verifying) pass or fail of the test target function based on the foregoing input and output. Usually, the verification of the operation description must be executed with respect to various input values having different value.

Therefore, the C test bench description (test program) verifies the operation description with respect to various input values having different value. Thus, the C test bench description includes a plurality of test descriptions corresponding to a plurality of input values. Each test description includes first and second codes, for example.

The first code is used for executing input/output with the operation description (test target function). Specifically, the first code calls a test target function expressing the LSI operation included in the operation description. The first code further gives an input value to the test target function and acquires an output value from the operation description (the test target function).

The second code is used for determining whether or not the relationship between an input value given to the operation description b the first code corresponding to the second code and the output value acquired from the operation description is correct. Specifically, the second code is a code for determining whether or not the relationship between the input value and the output value is an expected relation according to predetermined verification algorithm.

The test bench description analysis module 102 analyzes a C test bench description (source file of test program) stored in the test bench description storage module 10. Thereafter, the module 102 detects that which part of the C test bench description is a portion (first code) calling a test target function (operation description) based on the analysis result. For example, the C test bench description may be added with a flag/comment for specifying a portion calling the test target function. In this case, the module 102 can detect the portion calling the test target function in the C test bench description. In addition, a function naming rule may be predetermined. In this case, the module 102 can predict a function name used for the test target function based on the naming rule. Thus, the module 102 detects the portion calling the test target function included in the C test bench description. The module 102 can further detect the second code included in the C test bench description.

The test bench information storage module 103 stores information acquired by the analysis of the test bench description analysis module 102, that is, information related to the first code as test bench information.

The result judgment function designation information receiver module 104 receives input information for designating which part of the C test bench description stored in the test bench description storage module 101 is a result judgment description portion (second code). The input information is obtained from user, for example. Of course, the module 102 or other tool analyzes the C test bench description to detect which part of the C test bench description is a portion (second code) corresponding to the result judgment description. Then, the module 102 or other tool gives a notification of the detection result to the result judgment function designation information receiver module 104. The foregoing flag/comment and the naming rule are usable for the processing for detecting the result judgment description portion (second code).

Incidentally, the result judgment description portion (second code) is not necessarily described as one independent function. The result judgment description portion (second code) may be formed of a plurality of code groups including at least function for determining whether or not the relationship between the input and output values is an expected relation according to predetermined verification algorithm.

The result judgment function information storage module 105 stores the result judgment description portion (second code).

The pipeline stage number receiver module 106 receives input information (cycle number information) for designating an execution cycle number required until an output value corresponding to an input value is output from a RTL description (hardware model) after the input value is input to the RTL description (hardware model). For example, the input information is given from user. The execution cycle number of the RTL description (hardware model) is suggested to user via a report from the high-level synthesis tool 20 generating the RTL description. Thus, the user can input the execution cycle number to the module 106.

The RTL description generated by the high-level synthesis tool 20 expresses the configuration of a pipeline circuit, which successively executes each processing to the input values as a hardware model. In this case, the foregoing execution cycle number is given by a pipeline stage number included in the pipeline circuit. Cycle number information such as the pipeline stage number input by the pipeline stage number receiver module 106 is stored in the pipeline stage number information storage module 107.

Incidentally, the cycle number information such as the pipeline stage number is not always input by user. For example, the pipeline stage number receiver module 106 can automatically input the cycle number information such as the pipeline stage number from the high-level synthesis tool 20.

The drier function generator module 108 generates a driver function based on the content of the RTL description (hardware model). The driver function is a function for executing an input/output operation to the RTL description (hardware model). The driver function receives each input value successively given from the test program (C test bench description). Every time one input value is received, the driver function gives the received input value to the RTL description and returns the current output value of the RTL description to the test program. The driver function is generated using the method disclosed in the foregoing Publication No. 2007-310449, for example.

The driver call function generator module 109 extracts information related to the test target function in the operation description (e.g., function name of test target function, number of argument, argument type) from test bench information stored in the test bench information storage module 103, that is, information related to the first code. The module 109 generates a driver call function based on information related to the extracted test target function. The driver call function has the same function name as the test target function, and is called every first code execution. The driver call function is used as a function for changing the test target function call by the first code to the foregoing driver function call.

When the driver call function is called by the first code of the test program, the driver call function calls the driver function. Then, the driver call function gives an input value received from the first code of the test program to the driver function, and returns the current output value of RTL description returned from the driver function to the first code of the test program.

Also, the driver call function generator module 109 can directly extract information related to the test target function from a test program (C test bench description) stored in the test bench description storage module 101. In addition, the following rewrite may be executed in place of calling the driver function via the driver call function. Namely, a function name of the test target function in the first code of the test program is rewritten as a function name of the driver function. In this way, it is possible to call the driver function directly from the test program.

The result judgment function change module 110 changes a result judgment processing function of the test program (C test bench description) based on the following information. One is result judgment function information stored in the result judgment function information storage module 105. Another is cycle number information (pipeline stage number) stored in the pipeline stage number information storage module 107. Specifically, the module 110 extracts information related to a function for determining pass or fail (e.g., function name of result judgment function, number of arguments, argument type) from the following information. One is the test program (C test bench description) stored in the test bench description storage 101. Another is result judgment function information stored in the result judgment function information storage module 105. Then, the module 110 generates a new judgment processing function based on the extracted information and cycle number information input by the result judgment function designation information receiver module 104.

The RTL description expresses a hardware model, which successively executes processing with respect to each of the input values. In this case, the hardware model successively inputs a series of input values every clock cycle, and predetermined clock cycle only elapsed, and thereafter, successively outputs a series of output values corresponding to the series of input values every clock cycle. For example, the pipeline stage number is 3, the hardware model successively inputs a series of input values (input data 1, 2, 3, 4, 5, . . . ) every clock cycle. When inputting a fourth input value (input data 4), the hardware model outputs an output value (processing result data) corresponding to the first input value (input data 1). Then, when inputting a fifth input value (input data 5), the hardware model outputs an output value (processing result data) corresponding to the second input value (input data 2).

In order to correctly verify the operation of the hardware model, a new judgment processing function includes a mechanism for shifting a judgment processing timing. Specifically, the new judgment processing function starts a judgment processing when the following condition is satisfied. According to the condition, the number of time receiving a pair of input and output values from the test program exceeds an execution cycle number shown by the cycle number information. According to the judgment processing, the judgment processing function determines whether or not the relationship between the input value and the output value corresponding to the input value is an expected relation every input value received from the test program.

More specifically, the judgment processing function executes the following three procedures. For example,

(1) Procedure of receiving each pair of input and output values successively supplied from the test program;

(2) Procedure of holding (saving) the received input value in a buffer functioning as a storage area every time input and output values are received from the test program; and

(3) Procedure of reading the oldest input value held in the buffer when satisfying the condition that the number of time receiving a pair of input and output values from the test program exceeds an execution cycle number shown by the cycle number information, and of determining whether or not the relationship between the read input value and the latest output value received from the test program is an expected relation according to predetermined verification algorithm.

The judgment processing function has the same function name as a result judgment function called by the second code. The judgment processing function is called from the test program every execution of the second code.

The input value hold buffer generator module 111 generates the foregoing buffer for holding some input values. The buffer size is at least pipeline stage number or more.

The conversion result storage module 112 is a module for storing the following functions. One is a driver function generated by the driver function generator module 108. Another is a driver call function generated by the driver call function generator module 109. Another is a judgment processing function generated by the result judgment function change module 110.

The foregoing driver function, driver call function and judgment processing function are used, and thereby, the test program (C test bench description) for verifying the operation description is reusable for verifying the RTL description. In other words, the foregoing driver function, driver call function and judgment processing function as software for verifying the RTL description (RTL test bench description) in associated with the test program (C test bench description) for verifying the operation description. In the software for verifying the RTL description (RTL test bench description), the test program for verifying the operation description is reused.

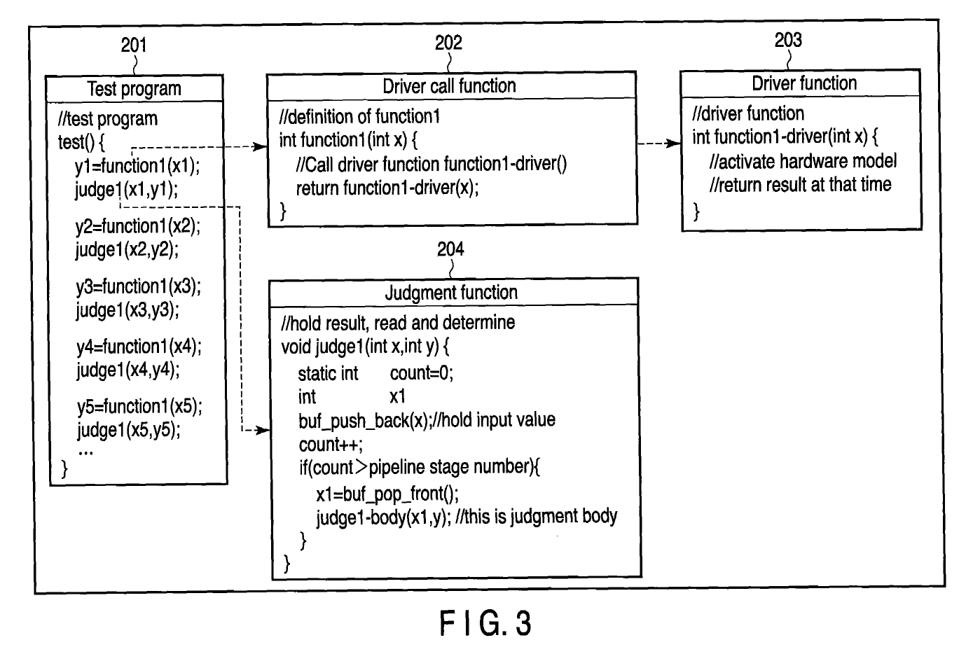

A software (RTL test bench description) example generated by the software generation apparatus 10 will be explained below with reference to FIG. 3.

The RTL test bench description is a program for verifying the RTL description.

As described above, the RTL test bench description is generated using the test program (C test bench description).

In FIG. 3, 201 denotes a test program (C test bench description). According to the description example of the test program 201, a test target function in the operation description in C is function1( ), a result judgment function is judge( ). Specifically, y1=function1(x1) corresponds to the foregoing first code, and judge1(x1,y1) corresponds to the foregoing second code.

In this case, the test target function “function1( )” receives a single integer argument, and returns a single integer calculation result.

In FIG. 3, “y1=function1(x1)” is a code for executing the following procedure. The code “y1=function1(x1)” calls the test target function “function1( )” in the operation description, and gives an input value XI to the test target function “function1( )” to acquire an output Y1 from the operation description. “judge1(x1,y1)” is a code for executing the following procedure. The code “judge1(x1,y1)” determines whether or not the relationship between the input value x1 and the output value y1 is an expected relation according to predetermined verification algorithm. The codes “y1=function1(x1)” and “judge1(x1, y1)” form the first test description.

Likewise, the codes “y2=function1(x2)” and “judge1(x2, y2)” form the second test description, and the codes “y3=function1(x3)” and “judge1(x3, y3)” form the third test description. Likewise, the codes “y4=function1(x4)” and “judge1(x4, y4)” form the fourth test description, and the codes “y5=function1(x5)” and “judge1(x5, y5)” form the fifth test description.

When the test program 201 is executed, a plurality of test descriptions each including the first and second codes is sequentially executed.

202 denotes a driver call function. The driver call function is a function of changing a call of “function1( )” by the first code to call of the driver function “function1-driver( )”. The driver call function 202 is called every time the first code is executed. In other words, the driver call function 202 has the same function name as the test target function “function1( )” to be called by the first code.

The driver call function 202 calls a driver function 203, and gives an input value received from the first code to the RTL description via the driver function 203. Then, the driver call function 202 returns to the first code the current output value of the RTL description (hardware model) returned from the driver function 203.

The driver function 203 is a function for controlling the RTL description. The driver function 203 is configured to soon return a current output value of the RTL description when an input value is input to the RTL description, and does not wait until an output value corresponding to the input value is returned from the RTL description. The driver function 203 is not necessarily automatically generated, and the user can manually generate the driver function by a coding (programming) based on the content of the RTL description.

204 denotes the foregoing judgment processing function (hereinafter, referred to as a judgment function). The operation description (test target function) in C instantaneously returns an output corresponding to input. Thus, when the operation description is verified, the test program 201 immediately executes a processing for determining whether or not the relationship between the input and output values is an expected relation. However, when the RTL description (hardware model) including the pipeline circuit is verified, the output corresponding to the input is not returned soon from the RTL description. For this reason, when the RTL description is verified, execution of the processing for determining whether or not the relationship between the input and output values is an expected relation must wait until an output corresponding to the input is returned. In addition, during this waiting, the following input values must be successively given to the RTL description. Thus, the judgment function 204 includes the following procedures as described before. For example,

(1) Procedure of holding the input value received from the second code in the buffer; and

(2) Procedure of reading the oldest input value held in the buffer when satisfying the condition that the number of input values received from the test program, that is, the number of times of calling the judgment function 204 from the test function, exceeds an execution cycle number (pipeline stage number), and of determining whether or not the relationship between the read input value and the latest output value received from the test program is an expected relation.

The judgment function 204 has the same function name as the result judgment function included in the second code, the judgment function 204 is called when the second code is executed. The judgment function 204 receives two integer arguments “x”, “y”. The “x” is a input value to be given to the operation description or the RTL description, and the “y” is an output value from the operation description or the RTL description. When the judgment function 204 is called by the second code, the judgment function 204 receives the input value “x” and the output value “y” from the second code.

In the judgment function 204, “count” is a variable for counting the number of times of calling the judgment function 204. “count++” is a description for counting up the number of times of calling the judgment function 204. “buf_push_back(x)” is a description for temporally holding an input value in a buffer. “if(count>pipeline stage number)” is a description for determining whether or not the condition that the number of times of calling the judgment function 204 exceeds an execution cycle number (pipeline stage number) is satisfied. “x1=buf_pop_front( )” is a description for reading the oldest input value held in the buffer. “judge1-body (x1, y)” is a description for determining whether or not the input value x1 read from the buffer and the current output value y received from the second code have an expected relation.

For example, if the pipeline stage number is 3, a timing when the output value y4 corresponding to the first input value x1 is returned from the RTL description corresponds to a timing when the input value x4 for the fourth test description is given to the RTL description. In this case, the judgment function 204 starts the result judgment processing when being called by the second code included in the fourth test description. According to the result judgment processing, the oldest input value held in the buffer (i.e., input value x1) is fetched from the buffer. Then, it is determined whether or not the relationship between the input value x1 and the latest output value y received from the second code (i.e., output value y4 from RTL description corresponding to the input value x1) is an expected relation.

FIG. 4 is a flowchart to explain the procedure executed by the judgment function 204.

Every time the second code of the test program 201 is executed, the judgment function 204 is called by the second code. In this case, the judgment function executes the following procedure.

The judgment function 204 receives a pair of input and output values from the second code, and then, holds the received input value in the buffer (step S101). Thereafter, the judgment function 204 updates the variable “count” value +1 (step S102). The judgment function determines whether or not the current variable “count” value is larger than the pipeline stage number (step S103).

If the current variable “count” value is not larger than the pipeline stage number (NO in step S103), the judgment function ends, and then, the control is returned to the test program 201.

If the current variable “count” value is larger than the pipeline stage number (YES in step S103), the judgment function 204 reads the oldest input value held in the buffer (step S104). Thereafter, the judgment function 204 determines whether or not the relationship between the read input value and the latest output value received from the second code is an expected relation (step S105).

The following is an explanation about the procedure of generating the driver call function 202, the driver function 203 and the judgment function 204.

<Generation of Driver Call Function 202>

The driver call function 202 is generated according to the following procedures.

(1) The software generation apparatus 10 extracts information related to the test target function called by the first code from the operation description in C or C test bench description. The information includes a function name of the test target function, a return value type handled by the test target function, the number of arguments handled by the test target function and each argument type, etc.

(2) The software generation apparatus 10 generates a shell (frame) (“int function1(int x) { }”) of the driver call function 202 using the extracted information related to the test target function.

(3) The software generation apparatus 10 adds a description in the shell of the driver call function 202. This description includes a description of calling a driver function “function1-driver( )”, of giving an input value to the driver function “function1-driver( )”, and of returning the result from the driver function “function1-driver( )”.

<Generation of Driver Function 203>

The function name of the driver function 203 is already generated when the driver call function 202 is generated. Thus, the function name (“test target function name-driver”) is given as the function name of the driver function 203. A return value type handled by the driver function 203 and the number of arguments handled by the driver function 203 are the same as the test target function. The driver function 203 is generated according to the following procedures.

(1) The software generation apparatus 10 generates the function name of the driver function 203. Then, the apparatus 10 generates a function shell (“int function1-driver(int x) { }”) of the driver function using the same return value type and number of arguments as the test target function.

(2) The software generation apparatus 10 gives a description of activating hardware model (RTL description) to the function shell of the driver function. Then, the apparatus 10 adds a description to the driver call function 202. This description is a description of giving an input value received from the driver call function 202 to the hardware model, and of returning the current output value of the hardware model at that time.

<Generation of Judgment Function 204>

The same name as the result judgment function called by the second code is used as a function name of the judgment function 204. The number and type of arguments handled by the judgment function 204 and a return value type handled by the judgment function 204 can use the same as those handled by the result judgment function. Most of the content of the judgment function 204 is fixedly determined. A variable portion of the content of the judgment function 204 is a pipeline stage number. A pipeline stage number value is input from the high-level synthesis tool 20. A buffer is prepared. The judgment function 204 is generated according to the following procedure.

(1) The software generation apparatus 10 extracts information (function name of the result judgment function, return value type thereof, the number and type of arguments thereof) related to the result judgment function included in the second code, from the C test bench description.

(2) The software generation apparatus 10 generates a shell (“void judge1(int x, int y) { }”) of the judgment function using the extracted information related to the result judgment function.

(3) The software generation apparatus 10 adds a declaration of a static variable “count” for counting the number of call times of the judgment function 204 to the shell of the judgment function 204.

(4) The software generation apparatus 10 adds a declaration of a variable x1 to the shell of the judgment function 204. The variable x1 is used to shift a judgment timing of an input value x. The variable x1 is a local variable in the judgment function 204; therefore, the name of the variable x1 may be any forms so long as it is unique in the judgment function (x1 is given in this example).

(5) The software generation apparatus 10 adds a description (“buf_push_back(x);”) for storing the input data in the buffer to the shell of the judgment function.

(6) The software generation apparatus 10 adds a description (“count++;”) for counting up a variable “count” showing the number of call times of the judgment function 204.

(7) The result judgment is started at a timing when “an output having meanings” comes from the RTL description (hardware model). The timing comes after the judgment function 204 is called by the number of times of “pipeline stage number”. Specifically, the same number of test descriptions as the “pipeline stage number” in the test program is executed, thereby an input values having the number corresponding to the “pipeline stage number” are given to the RTL description. Thereafter, verification of the RTL description operation to the input value given to the RTL description by the first test description must be started. Therefore, the software generation apparatus 10 adds a condition judgment description (“if (count>pipeline stage number) { }”) of making a judgment after call is given by the number of times of the “pipeline stage number” to the shell of the judgment function 204. The pipeline stage number is actually expressed as a numerical value.

(8) The software generation apparatus 10 generates a description of fetching the oldest input value from the buffer and of executing the result judgment. The timing of executing the result judgment comes after the output having meanings appears as described above. The description of fetching the oldest input value from the buffer to execute the result judgment is generated in the foregoing “if” sentence. The description written in the second code is used as a function of executing the result judgment to be generated in the “if” sentence. In this case, the function name needs to be changed (here, “judge-body( )”). Namely, the apparatus 10 generates a description “x1=buf_pop_front( );” and a description “judge1-body (x1, y);” in the “if” sentence.

The foregoing procedures are executed, and thereby, it is possible to generate software for verifying the RTL description (driver call function 202, driver function 203, judgment function 204). The foregoing test program 201, driver call function 202, driver function 203 and judgment function 204 are compiled and linked, and thereby, the software for verifying the RTL description can be converted to a binary format.

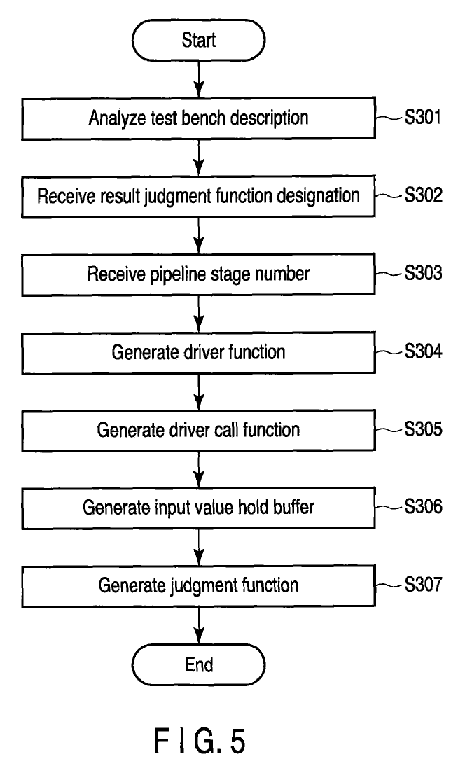

The test bench conversion procedure executed by the software generation apparatus 10 will be explained below with reference to a flowchart of FIG. 5.

The software generation apparatus 10 analyzes a C test bench description (step S301). In step S301, the test bench description analysis module 102 analyzes the C test bench description. Then, the module 102 extracts a portion (first code) calling a test target function (operation description) from the C test bench description. The apparatus 10 inputs information for designating a result judgment function (step S302). In step S302, the result judgment function designation information receiver module 104 receives input information supplied from the user, for example. The received input information shows which of the C test bench description is a result judgment portion (second code). Of course, the module 102 can analyze the C test bench description to extract the result judgment portion (second code) from the C test bench description.

Thereafter, the software generation apparatus 10 inputs cycle information showing pipeline stage number (step S303). In step S303, the pipeline stage number receiver module 106 inputs cycle information given from the user or the high-level synthesis tool 20, for example.

The software generation apparatus 10 generates a driver function 203 (step S304). In step S304, the driver function generation module 108 generates the driver function 203 based on the content of the RTL description (hardware model). Then, the apparatus 10 generates a driver call function 202 used for changing a call of the test target function to a call of the driver function 203 (step S305). In step S305, the driver call function generator module 109 extracts information related to the test target function from the information related to the first code. Then, the module 109 generates a driver call function 202 based on the extracted information related to the test target function. The same function name as the test target function is given to the driver call function 202. In this way, the driver call function 202 is called every time the first code is executed.

The software generation apparatus 10 generates a buffer (input value hold buffer) (step S306). In step S306, the input value hold buffer generator module 111 generates an input value hold buffer, which has a size capable of holding the same number as at least pipeline stage number. Thereafter, the apparatus 10 generates a judgment function 204 (step S307). In step S307, the result judgment function change module 110 extracts information related to the result judgment function included in the second code. Then, the module 110 generates the judgment function 204 based on the extracted information and the cycle information. The same function name as the result judgment function is given to the judgment function 204. In this way, the judgment function 204 is called every time the second code executed. The judgment function 204 has a function of shifting (delaying) a timing of executing the result judgment by a number corresponding to the pipeline stage number.

As described above, according to this embodiment, the following advantage is obtained. Specifically, even if the LSI RTL description of successively executing each procedure of the input values is given, it is possible to automatically generate software capable of correctly verifying the RTL description using the test program for verifying the operation description. In this case, the input group and the result judgment algorithm described in the operation description verification test program is usable for verifying the RTL description without changing.

According to this embodiment, the driver call function generator module 109 and the result judgment function generator module 110 are provided as a module independent from the test bench description analysis module 102. These modules 109 and 110 may have a source program analysis function equivalent to the test bench description analysis module 102. In this case, the module 109 analyzes the test program to extract information related to the test target function from the test program, and based on the extracted information, generates the driver call function 202. The module 110 analyzes the test program to extract information related to the result judgment function included in the second code from the test program. Then, the module 110 generates the judgment function 204 based on the extracted information and the input cycle number information.

According to this embodiment, the judgment function counts the number of called times, and then, based on the count value, determines whether or not the number of times calling the judgment function, that is, the number of times of receiving a pair of input and output values from the test program exceeds the execution cycle number. In this case, it may be determined whether or not the number of times calling the judgment function, that is, the number of times of receiving a pair of input and output values from the test program exceeds the execution cycle number based on whether or not the buffer is in a full state filled with a plurality of input values.

According to this embodiment, the judgment function 204 shifts the judgment timing by holding each of the input values received from the test program in the buffer. In this case, for example, the present invention is not limited to the buffer, and the judgment timing may be shifted using an array or list structure capable of holding the input values.

According to this embodiment, the judgment function is called directly from the second code. For example, another function having the same function name as the result judgment function included in the second code is generated to call the judgment function from the foregoing another function. In this case, the function name of the judgment function has no need of making the same as the result judgment function.

According to this embodiment, the test bench conversion function is realized by a computer program. Thus, the computer program is installed in a normal computer via a computer readable storage medium stored with the computer program. In this way, the same effect as this embodiment is easily realized.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A software generation apparatus for generating software for verifying a RTL description obtained by high-level synthesis of an operation description describing an LSI operation using a high-level programming language, comprising:
a storage device configured to store a test program for verifying the operation description; and
a judgment function generation module configured to generate a judgment function based on the test program and an execution cycle number indicating a cycle number spent until an output value corresponding to an input value is output after the RTL description inputs the input value, the judgment function starting a process of determining whether the relationship between the input value and the output value is an expected relation when the number of times of receiving a pair of an input value and an output value from the test program exceeds the execution cycle number, and the test program and the judgment function functioning as the software.

2. The apparatus of claim 1, wherein the judgment function executes the following procedures of:
receiving each pair of an input value and an output value successively given from the test program;
holding the received input value in a buffer when a pair of an input value and an output value is received from the test program; and
reading the oldest input value held in the buffer when the number of times of receiving a pair of an input value and an output value from the test program exceeds the execution cycle number, and determining whether or not the relationship between the read input value and the latest output value received from the test program is an expected relation according to predetermined verification algorithm.

3. The apparatus of claim 1, wherein the test program includes a plurality of test descriptions each having a first code giving an input value to the operation description and acquiring an output value from the operation description, and a second code including a function for determining whether or not the relationship between the input value and the output value is an expected relation, and
the judgment function is called by the second code when the second code is executed.

4. The apparatus of claim 1, further comprising:
a driver function generator module configured to generate a driver function of receiving each input value successively given from the test program, of giving the received input value to the RTL description when one input value is received, and of returning the current output value of the RTL description to the test program.

5. The apparatus of claim 3, wherein the judgment function counts the number of times calling the judgment function, and when the count value exceeds the execution cycle number, determines that the number of times of receiving a pair of an input value and an output value from the test program exceeds the execution cycle number.

6. The apparatus of claim 3, wherein the first code includes a description of calling a predetermined function expressing the LSI operation included in the operation description, of giving an input value to the predetermined function, and of acquiring an output value from the operation description, and
the apparatus further comprises:
a driver function generator module configured to generate a driver function of receiving each input value successively given from the test program, of giving the received input value to the RTL description when one input value is received, and of returning the current output value of the RTL description to the test program; and
a driver call function generator module configured to extract information related to the predetermined function from the test program, and based on the extracted information, and to generate a driver call function called every time the first code is executed, the driver call function including a function for calling the driver function, for giving an input value received from the test program to the driver function, and further, and for returning the current output value of the RTL description returned from the driver function to the test program.

7. The apparatus of claim 1, wherein the RTL description obtained by the high-level synthesis expresses a configuration of a pipeline circuit for successively executing processing with respect to each of a plurality of input values, and
the execution cycle number shows a pipeline stage number included in the pipeline circuit.

8. The apparatus of claim 7, wherein a value showing the pipeline stage number of the pipeline circuit is input from a high-level synthesis processing program for executing the high-level synthesis.

9. A method of generating software for verifying a RTL description obtained by high-level synthesis of an operation description describing an LSI operation using a high-level programming language, comprising:
inputting execution cycle number information indicating an execution cycle number spent until an output value corresponding to an input value is output after the RTL description inputs the input value; and
generating a judgment function based on the execution cycle number information and a test program for verifying the operation description, the judgment function starting a process of determining whether the relationship between the input value and the output value is an expected relation when the number of times of receiving a pair of an input value and an output value from the test program exceeds the execution cycle number, and the test program and the judgment function functioning as the software.

10. The method of claim 9, wherein the judgment function executes the following procedures of:
receiving each pair of an input value and an output value successively given from the test program;
holding the received input value in a buffer when a pair of an input value and an output value is received from the test program; and
reading the oldest input value held in the buffer when the number of times of receiving a pair of an input value and an output value from the test program exceeds the execution cycle number, and determining whether or not the relationship between the read input value and the latest output value received from the test program is an expected relation according to predetermined verification algorithm.

11. A program stored in a computer readable medium, configured to generating software for verifying a RTL description obtained by high-level synthesis of an operation description describing an LSI operation using a high-level programming language, comprising:
casing a computer to input execution cycle number information indicating an execution cycle number spent until an output value corresponding to an input value is output after the RTL description inputs the input value; and
casing a computer to generate a judgment function based on the execution cycle number information and a test program for verifying the operation description, the judgment function starting a process of determining whether the relationship between the input value and the output value is an expected relation when the number of times of receiving a pair of an input value and an output value from the test program exceeds the execution cycle number, and the test program and the judgment function functioning as the software.

12. The program of claim 11, wherein the judgment function executes the following procedures of:
receiving each pair of an input value and an output value successively given from the test program;
holding the received input value in a buffer when a pair of an input value and an output value is received from the test program; and
reading the oldest input value held in the buffer when the number of times of receiving a pair of an input value and an output value from the test program exceeds the execution cycle number, and determining whether or not the relationship between the read input value and the latest output value received from the test program is an expected relation according to predetermined verification algorithm.
